(19) United States
(12) Patent Application Publication
(10) Pub. No.: US 2002/0042718 A1
(43) Pub. Date: Apr. 11, 2002

(54) Point of purchase dynamic architecture

(76) Inventor: Price Jett, Fredericksburg, VA (US)

Correspondence Address: DENIS G. MALONEY, Fish & Richardson P.C., 225 Franklin Street, Boston, MA, 02110-2804, US

(21) Appl. No.: 09/963,105

(22) Filed: Sep. 25, 2001

Related U.S. Application Data
(60) Provisional application No. 60/234,920, filed on Sep. 25, 2000.
(60) Provisional application No. 60/234,918, filed on Sep. 25, 2000.
(60) Provisional application No. 60/235,274, filed on Sep. 25, 2000.

(51) Int. Cl. G06F 17/60

(52) U.S. Cl. 705/1; 705/16; 705/50

(57) ABSTRACT

A point of purchase method for conducting electronic commerce includes a presentation process for interfacing with a plurality of remote systems, an integration process for presenting a plurality of scripts to the remote systems, and an applications process for performing electronic commerce.

### CLAIM OF PRIORITY

This application claims priority under 35 USC §119(e) to U.S. patent application Ser. No. 60/234,920, filed on Sep. 25, 2000, entitled, “Point of Purchase Dynamic Architecture,” U.S. patent application Ser. No. 60/234,918, filed on Sep. 25, 2000, entitled, “Point of Purchase Dynamic Security Architecture,” and U.S. patent application Ser. No. 60/235,274, filed on Sep. 25, 2000, entitled, “Point of Purchase Dynamic Advertisement Coding Architecture,” the entire contents of which are hereby incorporated by reference.

### TECHNICAL FIELD

This invention relates an architecture to conduct electronic commerce.

### BACKGROUND

Business transactions are rapidly changing due to technological advancements supporting, among other platforms, wireless platforms. Wireless is a term used to describe telecommunications where a client device propagates and receives electromagnetic energy through space, which energy carries information between the client device and a server over a network. Common examples of wireless client devices in use today include cellular phones and pagers that provide connectivity for portable and mobile applications, both personal and business, and wireless personal digital assistants. Conducting E-commerce from a wireless platform, as well as from more traditional platforms, presents issues for technology and marketing departments of retailers and wholesalers.

### SUMMARY

According to one aspect of the invention, a point of purchase method includes providing a plurality of application sub-processes that interact a client device with a server device, where the client device is prompted to divulge profile information of the user, and in exchange, the server sends the client device a reward that can represented as a token to allow the user to achieve an advantage in purchasing goods and/or services. One or more features may also be included.

A presentation process includes translators and device specific presentation for interfacing with a plurality of remote systems. The method also can use an integration process for presenting a plurality of scripts to the remote systems. The plurality of scripts includes code scripts. The code scripts include Extended Markup Language (XML) code scripts, Java code scripts, Distributed Component Object Model (DCOM) code scripts, Hypertext Transfer Protocol (HTTP) code scripts, Linux code scripts and other source wrappers. The other source wrappers include data that precedes or frames main data or a first program that sets up a second program so that the second program can run successfully.

The applications process includes a plurality of sub processes. The plurality of sub processes includes a pricing sub process. The pricing sub process includes receiving a user connection, receiving a user identifier from a user, determining whether the user is contain in a user database, and offering incentives to the user if the user is in the user database. The incentives include pricing discounts.

The plurality of sub processes includes an order of dialogue sub process. The order of dialogue sub process includes receiving a user connection, receiving a user identifier of a user, loading user information associated with the user identifier from a user database, and presenting the user with a plurality of options according to a history associated with the user information. The plurality of options includes offering the user higher cost goods or services. The plurality of options includes offering the user an extended warranty.

The plurality of sub processes includes a future commit sub process. The future commit sub process includes receiving a user identifier from a user through a user connection, loading a user profile associated with the user identifier from a user database, presenting an option to the user, and applying a discount to a purchase if the user accepts the option. The sub process may further include penalizing the user if the user violates the option.

The plurality of sub processes includes a negotiation sub process. The negotiation sub process includes loading a user profile associated with a user identifier from a user database and determining a negotiation style for the user identifier. Determining the negotiation style includes maintaining a history of user transactions. The negotiation style may be aggressive or passive. The method may further include offering additional sales of products or services in accordance with the negotiation style.

The plurality of sub processes includes survey sub process. The survey sub process includes receiving a user identifier of a user, loading a user profile associated with the user identifier from the user database, determining whether the user will complete a survey in return for an incentive, and applying the incentive if the user completes the survey. The incentive may be a discount.

The plurality of sub processes includes currency aggregation sub process. The currency aggregation sub process includes receiving an amount of a first currency from a user, normalizing a value of the first currency amount, and storing the value in a user database associated with the user. The sub process may further include receiving a request for an amount of a second currency, and converting the value into the second currency.

The plurality of sub processes includes an electronic couponing sub process. The electronic couponing sub process includes receiving a user identifier from a user, loading a user profile associated with the user identifier from a user database, loading a product database from a supplier site, sending a predicted product volume for the user to the product database, receiving a discount from the product database, and applying the discount to a transaction of the user.

The plurality of sub processes includes a person-to-person micropayments sub process. The micropayments sub process includes receiving a user identifier from a user, querying the user for a transaction type, presenting the user with options for the transaction type, receiving an option selection from the user, connecting to a payment provider, and applying the option selection to the payment provider.

The plurality of sub processes includes cookie-free sub process that includes receiving sensitive credit information from a user, associating the sensitive credit information with a user identifier in a user database, and passing the user identifier without the sensitive credit information to another party.

The plurality of sub process includes an advertising code sub process that includes tagging advertisement with a code, receiving the code from a user and sending information related to the code to the user.

The plurality of sub processes includes a security sub process. The security sub process includes an Oscillating Nodal Encryption (ONE) key encryption. The ONE key includes rotating a server code and a user code in a plurality of groups, i.e., buckets. The plurality of buckets include a bucket representing a group of unique questions to a user, a bucket representing data specific information to a device utilized by a user, a bucket representing device specific information to a device utilized by the user, and a bucket representing environmental specific information.

Embodiments of the invention may have one or more of the following advantages. A point of purchase (POP) network includes a POP server system that provides numerous application processes for the wireless and wired market as it relates to POP commerce and POP marketing.

An applications process includes profiling through historical and/or real time customer and market data. An application process includes an order of dialogue process to handle levels of customer cross-selling and a surveying function that may use templates that are vendor customizable. A micropayment process handles aggregation of disparate credits, electronic couponing and person-to-person micro-payments. A cookie-free profiling process assists in customer database security.

The system provides for coding advertisements and providing consumers a way to request additional information pertaining to the advertisements by entering the code into a wireless device and/or wired device.

The system insures security in transactions conducted via wireless devices and/or web-based devices by including one or more of the following in the network: touch sensitive screen, finger print scan, voice print scan and iris scan. The system includes an oscillating nodal encryption (ONE) keying technique that uses a series of changing techniques to insure security of transactions and thwarts unauthorized use of client devices.

Other features and advantages of the invention will become apparent from the following description, including the claims and drawings.

### DESCRIPTION OF DRAWINGS

FIG. 1 is block diagram of a point of purchase network.

FIG. 2 is flow diagram of the point of purchase (POP) process of FIG. 1.

FIG. 3 is s flow diagram of an application process used in the POP process of FIG. 2.

FIG. 4 is a flow diagram of a pricing sub process used in the applications process of FIG. 3.

FIG. 5 is a flow diagram of an order of dialogue sub process used in the applications process of FIG. 3.

FIG. 6 is a flow diagram of a future commit sub process used in the applications process of FIG. 3.

FIG. 7 is a flow diagram of a negotiation sub process used in the applications process of FIG. 3.

FIG. 8 is a flow diagram of a survey sub process used in the applications process of FIG. 3.

FIG. 9 is a flow diagram of an electronic couponing sub process used in the applications process of FIG. 3.

FIG. 10 is a flow diagram of a person-to-person micropayments sub process used in the applications process of FIG. 3.

FIG. 11 is a flow diagram of an advertising sub process used in the applications process of FIG. 3.

FIG. 12 is a flow diagram of a security sub process used in the applications process of FIG. 3.

FIG. 13 is a block diagram of a computer system.

### DETAILED DESCRIPTION

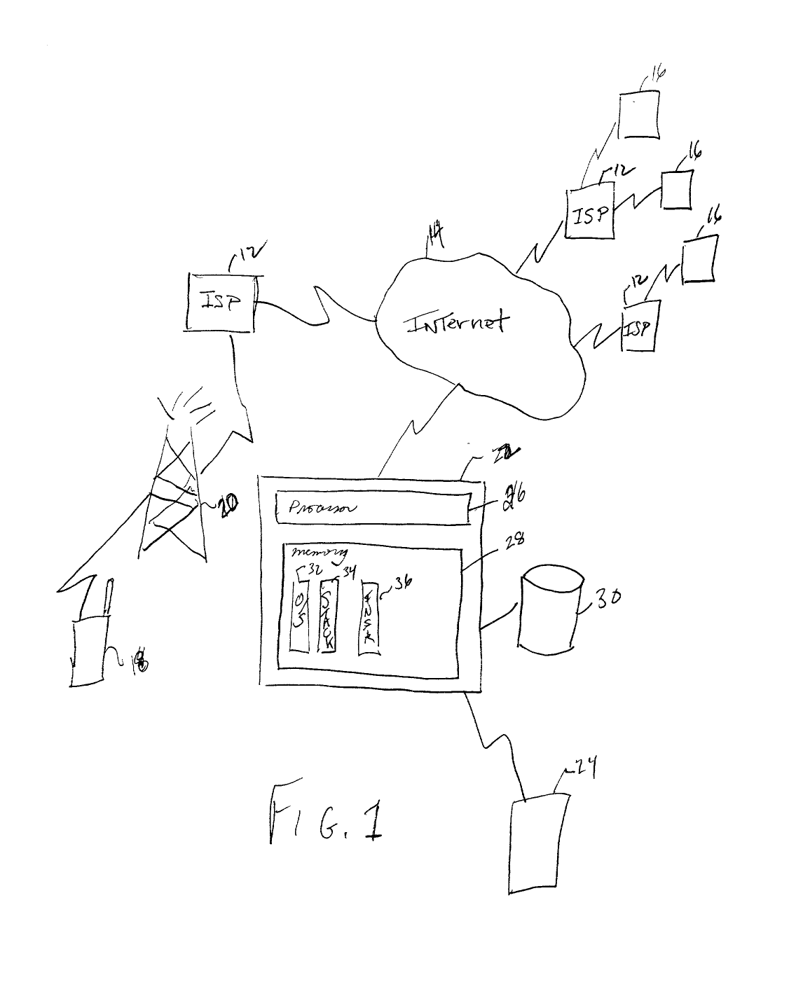

Referring to FIG. 1, a point of purchase (POP) network 10 includes a number of Internet Service Providers (ISPs) 12 that provide connection to the Internet 14 for a number of remote systems 16. A wireless device 18 is connected to the Internet 14 through an ISP 12 and a wireless service provider access tower 20. The point of purchase network 10 also includes a POP server system 22. Users (not shown) of the remote systems 16 access the POP server system 22 via the ISPs 12 and Internet 14, or through a user device 24 that is directly connected to the POP server system 22.

Exemplary wireless devices 18 and user devices 24 are web-enabled cellular phones, Windows CE devices, handheld personal computers (PCs), web-enabled personal data assistants (PDAs), and web-enabled televisions (TVs). Each of the remote systems 16, wireless devices 18, and user devices 24 has access to the POP server system 22 either through the ISP 12 or through a direct link.

The POP server system 22 includes, for example, a processor 26, a memory 28, and a storage device 30. Memory 28 stores an operating system 32 such as WindowsNT® or Linux®, a TCP/IP protocol stack 34 for communicating over Internet 14, and machine-executable instructions 36 executed by processor 26 to perform a point of purchase process 100 below.

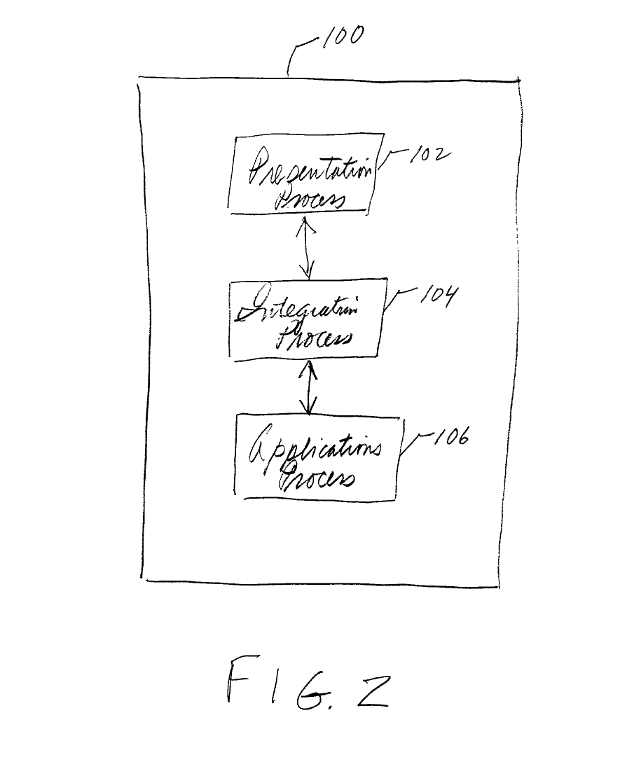

Referring to FIG. 2, the point of purchase (POP) process 100 includes a presentation process 102, an integration process 104 and applications process 106. The presentation process 102 includes translators and device specific presentation rules for interfacing with the remote systems 16, wireless devices 18, and user devices 24. The integration process 104 includes various code scripts such as Extended Markup Language (XML), Java®, CORBA, DCOM, HTTP, Linux, and other source wrappers. Such presentation and integration processes 102 and 104 are generally conventional and are used to interface application processes to the server 22 via a wireless network. The applications process 106 provides numerous processes for wireless and wired electronic commerce and marketing, as will be described below. One exemplary feature of the applications process is that it includes a plurality of sub-processes, at least some of which interact the client device e.g., 18 with the server 22 and where the server or through the server 22 client device is prompted to divulge profile information from the user, and in exchange the server 22 sends the client device a reward that can represent a token to allow the user to achieve an advantage in purchasing goods and/or services.

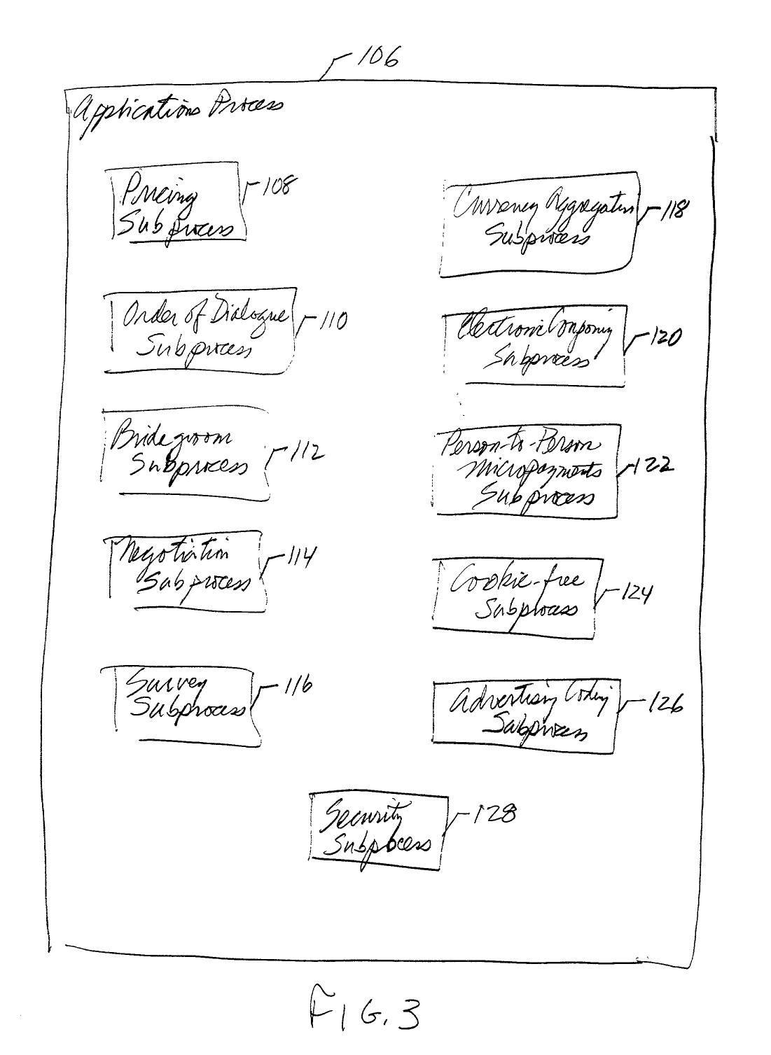

Referring to FIG. 3, the applications process 106 includes a pricing sub process 108, an order of dialogue sub process 110, a future commit sub process 112, a negotiation sub process 114, a survey sub process 116 and a currency aggregation sub process 118. The applications process 106 also includes an electronic couponing sub process 120, a person-to-person micropayments sub process 122, a cookie-free sub process 124, an advertising coding sub process 126 and security sub process 128. The sub processes 108-128 are modular and selectable by a control administrator (not shown) of the POP server system 22. Thus, the POP server system 22 may contain one or more of the sub processes 108-128.

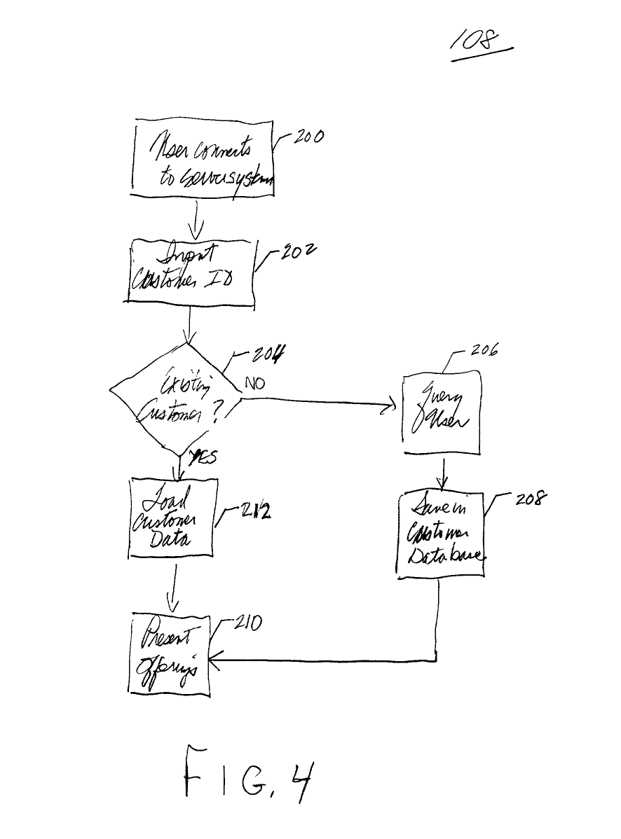

Referring to FIG. 4, the pricing sub process 108 includes a user connecting (200) to the POP server system 22. The sub process 108 receives (202) user input of a customer identifier and product code and the sub process 108 determines (204) whether the user is an existing customer. If the user is not an existing customer, the sub process 108 queries (206) the user and saves (208) a new customer identification and information as a customer profile before presenting (210) offerings to the user. If the user is an existing customer, the sub process 108 loads (212) the customer profile from a database (not shown) in the storage device 30 (of FIG. 1) and presents (210) offerings to the user. Customer profiles are maintained in a database management system (not shown), such as Oracle® from Oracle Corporation, ACCESS® from Microsoft Corporation, or Paradox® from Corel Corporation. Offerings include a variety of options related to products/services offered to the user, such as discount prices and peripheral products/services.

Sub process 108 facilitates an ability to uniquely tailor a price real-time at a point of purchase, such as a retail store for example, based on someone's customer profile as represented in the customer profile database. The sub process 108 allows the system administrator of the POP server system 22 to obtain knowledge that a particular user is looking at a product in a store and the customer database indicates, for example, that this consumer represents a 40% margin. Therefore, the store might offer the customer a 5% instant discount in this transaction.

A customer profile can contain information concerning the amount of money that a particular customer spends over the course of a period of time, e.g., a year. Another example of information contained in the customer profile is a frequency of store visits over a period of time, such as the number of visits per year by the customer. Another example of information that can reside in the customer profile is information that identifies the type of purchases by the customer. For example, customer who spends a certain amount of money that represents 40% gross margin as opposed to another customer who also spends the same amount of money, but only represents a 20% gross margin could be noted in the profile. In the POP architecture, each of the customers has a different customer profile. Each of the customers would receive a different price that would directly relate to their contribution to profitability, (i.e., profiling of purchasing trends, purchasing habits, etc. that are usually related to profitability). This profiling can be related to revenue. For example, a company may have as part of their goals to investors to increase revenue as opposed to profitability (e.g., to increase market share). A marketer can tailor the offerings to improve revenue without considering profits. Generally a customer profile that drives some behavior that represents a benefit to the company and its marketing goals, revenue, profits, frequency, etc.

An overall customer profile also uses historical data and real time data. Historical data is stored in the storage device 30 and reflects historical purchasing habits. Real time data involves, for example, asking the customer if he/she will agree to return to store three more times in the next twelve months. If the customer agrees to return, deeper discounts are offered to the customer. If the customer agrees and fails to return, the customer is, for example, penalized on their credit card. Embedded in the product code received (202) by sub process 108 is both information relating to the product and the store and its location. For example, the product code may indicate that the store.

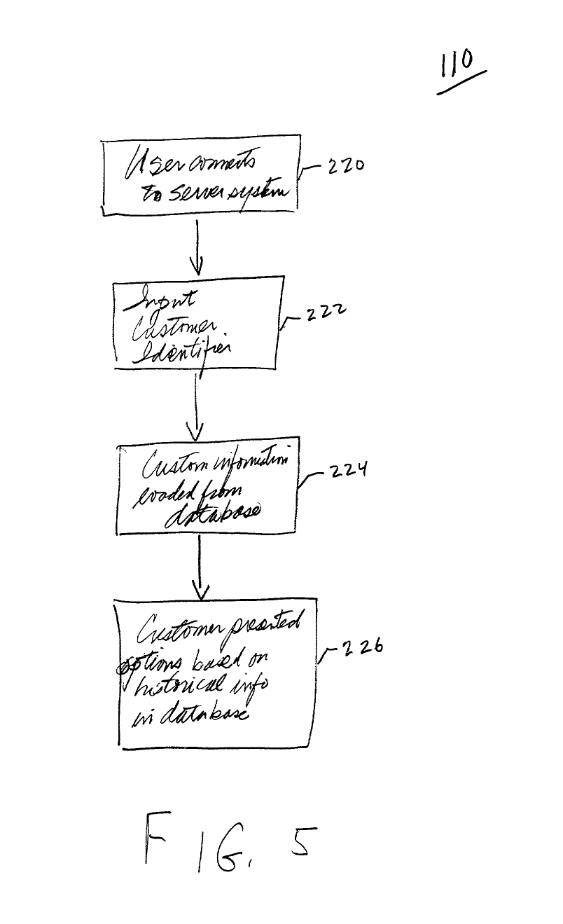

Referring to FIG. 5, the order of dialogue sub process 110 includes a user connecting (220) to the server system. The sub process 110 receives (222) the user customer identifier. The sub process 110 loads (224) customer information from the customer profile associated with the customer identifier from the customer profile database residing in the storage device 30 and presents (226) the user with options based on historical information contained in the user database.

By way of example, there are some customers who can be cross-sold, that is, if they are purchasing one item it is easy to sell them a second, related item. Other customers are not subject to such urges when an opportunity presents itself, i.e., they only buy the product they need. There are also some customers who are amenable to being “up sold,” i.e., if they a purchasing one item it is easy to sell them a more expensive item of the same kind. There are also other customers who are interested in additional things that may not be a product at all, but a service such as extended warranties associated with their purchase. The order of dialogue sub process 110 looks at stored historical data and makes assumptions as to customer behavior and weights options to be presented to the customer. For example, if customer A is in a store buying a VCR and nine out of ten times in the last year customer A always turned down an offer of an extended warranty, no extended warranty should be offered to customer A during this store visit.

Thus, the historical customer data builds strong customer relationships. An individual in a marketing department makes hypotheses about marketing initiatives and generates relationship links based on the historical data. These relationship links are stored in the relationship database and keyed to a customer identifier. This relationship database is maintained by the marketing department and can be manipulated using any database management system, such as Oracle® from Oracle Corporation, Access® from Microsoft Corporation, or Paradox®.

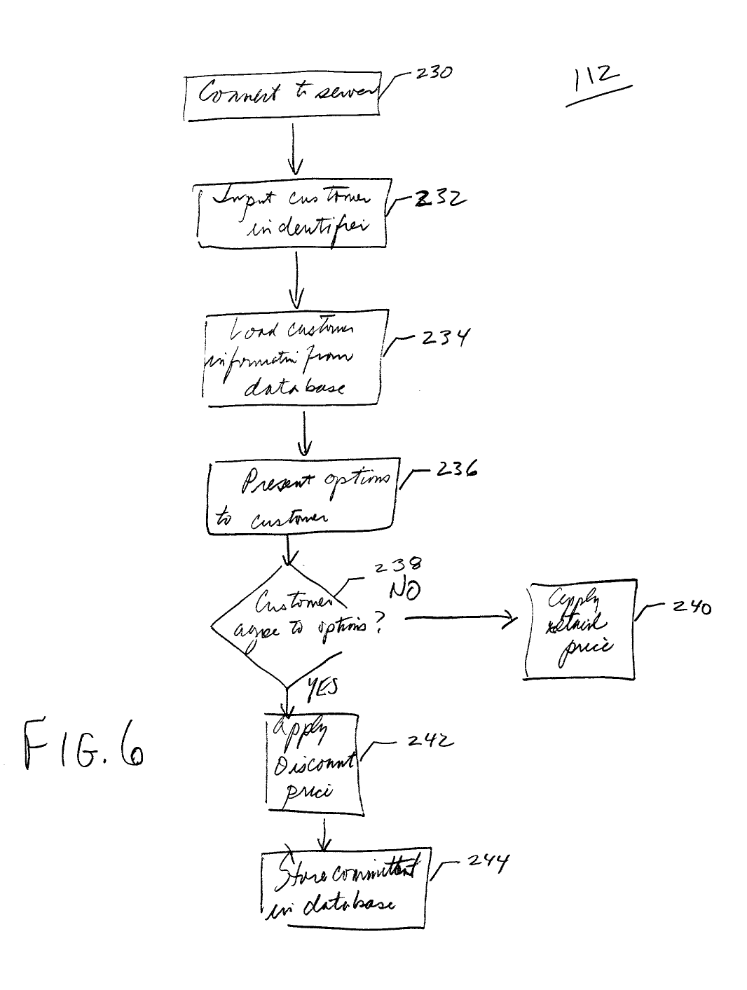

Referring to FIG. 6, the future commit sub process 112 is a process representative of one's willingness to commit to buying either a certain dollar amount of products/services in the future or agreeing to come back to a particular store location a defined number of times in the future. The future commit sub process 112 includes the user connecting (230) to the POP server system 22. The future commit sub process 112 receives (232) user input of a customer identifier and the future commit sub process 112 and loads (234) a customer profile associated with the customer identifier from the customer database. The future commit sub process 112 presents (236) one or more options to the customer and determines (238) whether the customer agrees to any of the presented options. If the customer does not agree to any of the presented options, the future commit sub process 112 applies (240) standard retail prices to purchases of products/services made by the customer. If the customer agrees to one or more of the presented options, the future commit sub process 112 applies (242) a discount price to customer purchases and stores (244) the customer commitment in the customer database associated with this customer's identifier.

The future commit sub process 112 provides information to permit a store to project into future revenue streams. For example, customer B has agreed to come back to our store three more times and we know from his customer profile he always buys $100 worth of products and always represents a 40% margin. Therefore, if customer B has agreed and we feel a high level of confidence that he will follow through on that commitment, three things can be predicted with better accuracy. The revenue generated by that store, profitability/margins and required inventory levels.

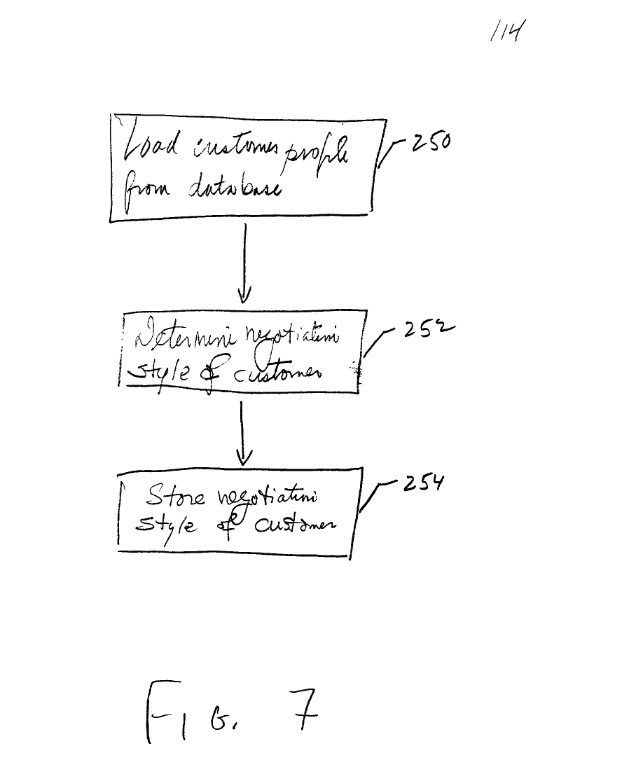

Referring to FIG. 7, the negotiation sub process 114 includes loading (250) a customer profile from the customer profile database and determining (252) a negotiation style of the customer. The negotiation sub process 114 stores (254) the negotiation style of the customer in the customer profile.

The negotiation sub process 114 provides a way in which the POP server system 22 can gain inferences related to a customer's profile. For example, credit card companies can see a customer's profile and bid against one another for the right to have that person as a customer in a transparent fashion, e.g., one institution offer a Visa® card can see what another institution that offers a MasterCard® is bidding for a customer and vice versa. The manner in which the consumer negotiates with those bidders tells something about his/her style. Some people are more aggressive negotiators than others. Capturing and monitoring this negotiating style gives the likelihood of whether one can cross sell or up-sell to the person in different stores. The negotiation process 114 indicates whether the person is more aggressive or more passive and the more passive the customer, one can determine particular “hot buttons” to attract the customer.

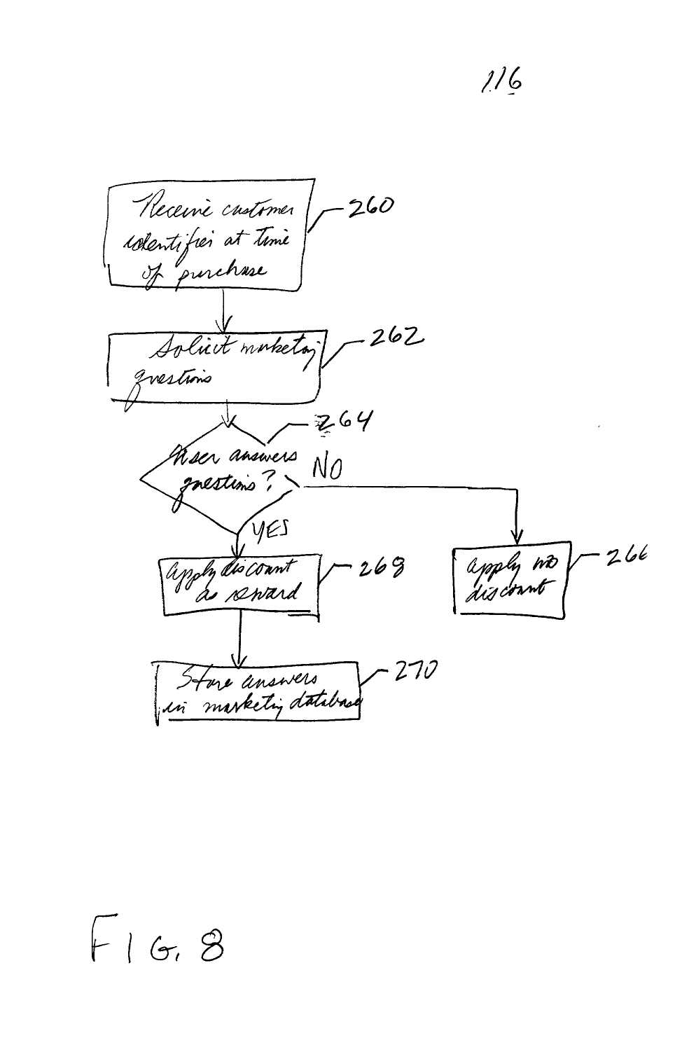

Referring to FIG. 8, the survey sub process 116 includes receiving (260) a customer identifier of a customer at a time the customer is about to purchase a product/service and soliciting (262) the customer to answer a series of short marketing questions. The survey sub process 116 determines (264) whether the customer answers the questions. If the customer does not answer the questions, the survey sub process 116 applies (266) no discount in price to the customer's purchase. If the customer does answer the questions, the survey sub process 116 applies (268) a discount to the customer's purchase and stores (270) the customer answers in a marketing database.

The survey sub process 116 allows a vendor to have preformatted templates from their marketing department to survey their customer base. Using the survey sub process 116, one can ask someone at the point of presence when they are interested in buying, for example a VCR, if the person would answer a couple of questions. If the person answers some question, the marketing department can offer the customer a discount on the product because this information is valuable to a as a marketer is valuable. The kinds of inquires that can be asked include: are you purchasing a VCR; why did you come to this store to purchase this VCR as opposed to another store, which may be closer to your home; are you here because you are a loyal customer of the store, or are you here because you are a loyal customer of the brand? The survey process provides an easy way for marketer's to collect such valuable information. This can be used by a marketing department to determine brand loyalty. The survey sub process 116 uses a built-in template and survey code that gathers the information and compiles the results for the marketing department for these particular surveys.

The currency aggregation sub process 118 aggregates multiple forms of electronic currency onto the POP server system 22. For example, in the marketplace today there is a company called Flooz. With Flooz, people can earn points or buy points. If a person wanted to send another person a gift, the first person could go online to Flooz and send the second person a gift worth $50. Flooz takes $50 out of the first person's credit card, puts it in their bank account and sends the second person an email saying they have a $50 credit with Flooz.

The second person can then go to the Flooz website and they have a list of merchants where the second person can purchase anything they want up to $50.

There are multiple affinity programs in the marketplace today such as frequent flyer points that you earn with your airline company or multiple airline companies. One can also earn points with rental car companies, and so forth. All of these points/incentives can be redeemed for merchandise. In essence, they are a form of electronic currency. The currency aggregation sub process 118 allows all of the different forms of currency to be aggregated together so that a person can redeem them for products/services that are normally not associated with any one specific incentive program.

The currency aggregation sub process 118 normalizes values of the different incentive program points to a dollar value, rounding up non-whole numbers to whole numbers. The normalization allows for the exchange of one type of incentive program point with another type of incentive program point. The currency aggregation process would communicate with servers operated by organizations that offer the various incentive programs that are aggregated in the sub process 118. The server 22 would become a portal for aggregated incentive programs that can be easily accessed by the client device.

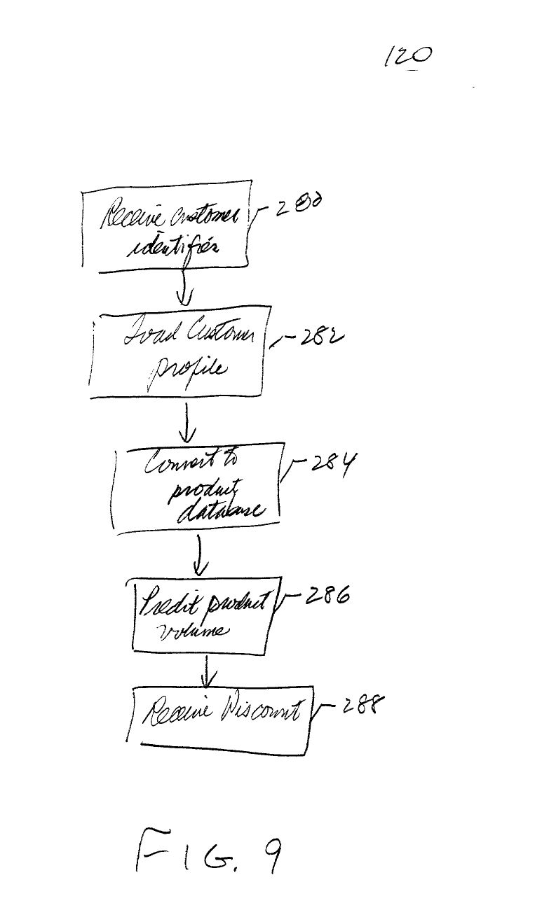

Referring to FIG. 9, the electronic coupon sub process 120 includes receiving (280) a customer identifier and a product name to be purchased. The electronic coupon sub process 120 loads (282) the customer profile associated with the customer identifier and connects (284) to a company database for the product. Using the customer profile, the electronic couponing sub process 120 predicts (286) a volume of the product that the customer might purchase over a year, based on historical information for this custom. The sub process 120 receives (288) a discount to be applied to the purchase by the customer from the company database at this time.

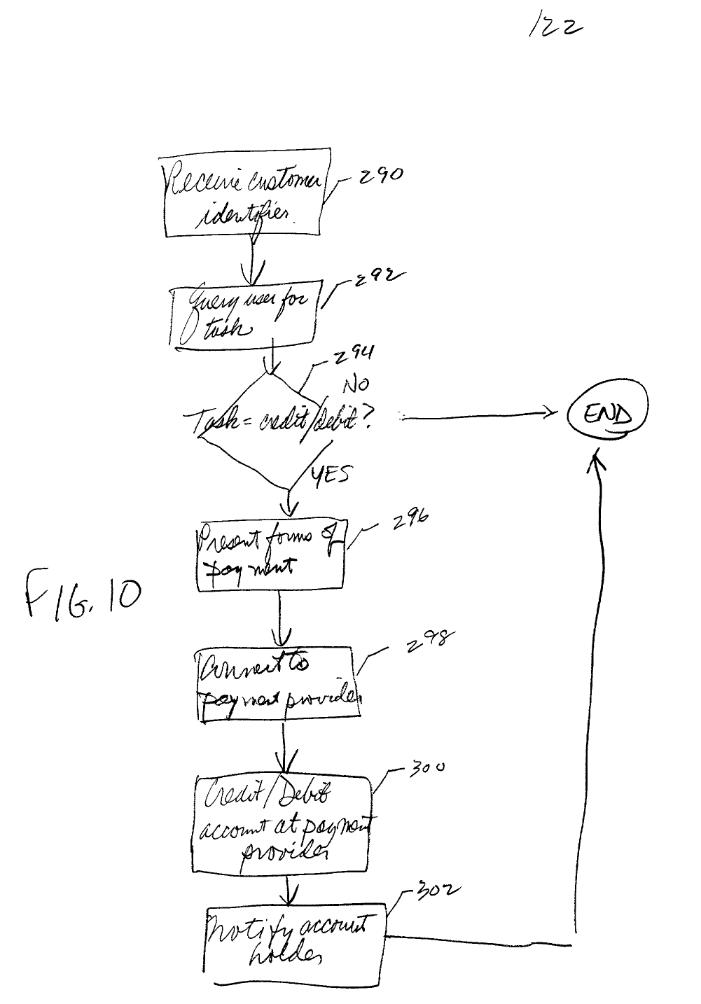

The person-to-person micropayments sub process 122 debits and credits accounts in real time. Referring to FIG. 10, the person-to-person micropayments sub process 122 includes receiving (290) a customer identifier. The sub process 122 queries (292) the customer to enter a task and determines (294) whether the task is a debit/credit. If the task is a debit/credit task, the sub process 122 presents (296) credit/debit options to the user. The sub process 122 connects (298) to a payment provider and credits/debits (300) an appropriate account of an account owner. The sub process 122 notifies (302) the account owner of the credit/debit.

Using sub process 122, a customer can use a number of payment types to pay for products and/or service for another individual. For example, the customer may want to use frequent flier mile credits, converted to a dollar amount, to credit the individual's VISA® card.

Cookie-free sub process 124 prevents sensitive information, such as profile information, web surfing information, possibly credit card information, etc., from being identified and possibly stolen. A cookie is information that a Web site puts on a user's hard disk (i.e., local storage device) so that it can remember something about the user at a later time. More technically, it is information for future use that is stored by a server on a client side of a client/server communication. Typically, a cookie records user preferences when using a particular site. Using the Web's Hypertext Transfer Protocol (HTTP), each request for a Web page is independent of all other requests. For this reason, the Web page server has no memory of what pages it has sent to a user previously or anything about previous visits. A cookie is a mechanism that allows the server to store information about a user on the user's own computer. For example, cookies are commonly used to rotate the banner ads that a site sends so that it doesn't keep sending the same ad as it sends during a succession of requested pages. Cookies can also be used to customize pages based on a user's browser type or other information provided to the Web site by the user. Web users generally agree to let cookies be saved, but, in general, cookies assist Web sites to better serve users.

In addition, cookies that sit on a computer generally generate web profiles. A user visits different server sites, the sites write cookies to the hard drive and read them later and determine where the user has been. Based on that information the computer makes some predictive assumptions about products they may or may not be of interest to the user. While these devices today have very little client size memory, there are reasons to avoid the use of cookies. For example, if someone steals a person's WAP enabled smart phone and starts making purchases, and the stolen smart phone had cookies stored on it, suppliers might think that the rightful owner of the phone is actually making the purchases. Thus, the user does not want his cookie profile to be easily stolen.

Another issue involves an air-to-wire security gap. If a user enters a credit card number into a cell phone, the credit card number is encrypted using WSL as it is transmitted from the phone to the tower. From the tower the information goes down to the ground to the wire. The information is unencrypted from WSL and re-encrypted in a short period of time, e.g., a millisecond more or less to SSL and then transmitted over the Internet. That millisecond where the number it is encrypted and unencrypted, the number can be vulnerable. A good hacker can grab the information while it is being unencrypted and re-encrypted and obtain credit card number and/or other information about the user.

The cookie-free sub process 124 eliminates the need for the POP server system 22 from requiring confidential information, e.g., credit card information, going over the wire at all. Confidential information remains in an encrypted state and the sub process 124 only passes a de-encryption key. The sub process 124 initially obtains the confidential information part of a customer profile.

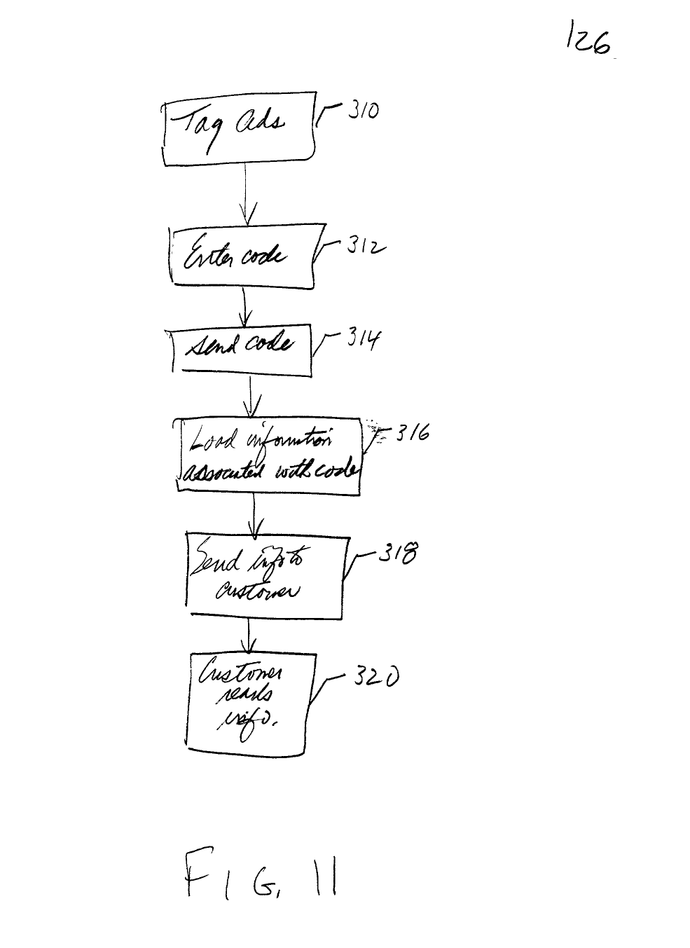

Referring to FIG. 11, the advertising coding sub process 126 includes tagging (310) print media such as billboards, TV ads, radio ads, and so forth, with a code. A consumer wishing information pertained to the advertisement enters (312) the code into a cell phone, for example, at a time when the advertisement is viewed or at some future time when the consumer wishes further information pertaining to the advertisement associated with the code. The code is sent (314) to the POP server system 22. The sub process 126 loads (316) information associated with the code and using electronic mail (E-mail) sends (318) the information to the consumer. The consumer reads (320) the information by looking through their personal E-mail account. The information that is sent to the user can be general information or it can be tailored to the specific user depending on profile information that is received from the user or which is stored on the server 22 for the user.

From an infomediary or marketer's point of view, the advertising coding process allows a company to easily communicate with consumers and obtain valuable marketing data on consumer preferences.

In an embodiment, the sub process 126 utilizes airwaves to send initial information to the consumer. For example, a consumer can be in the car listening to the radio. The consumer hears an ad for which it desires additional information. The car can include an alert indicator e.g., a light, a tone, and so forth, which alerts the consumer that the ad or the information that you just heard can be supplemented by additional information. The consumer can push another button in you're the car at which point the radio is shut off, and the server connects the wireless device to an internet connected radio connection. The device can be the wireless device or a device that is in the car to receive more information In another embodiment, the above sub process 126 is adapted for TV.

The sub process 126 uses airwaves so many alternate embodiments are possible. For example, pushing of the could allow continued listening to the radio while the server is signaled to send an email to the users email account with the additional information. This arrangement provides real time-direct marketing. This can be used to provide a service to advertisers on radio stations so they can measure the effectiveness of ads based on the number of contacts that go back to the server, and so forth.

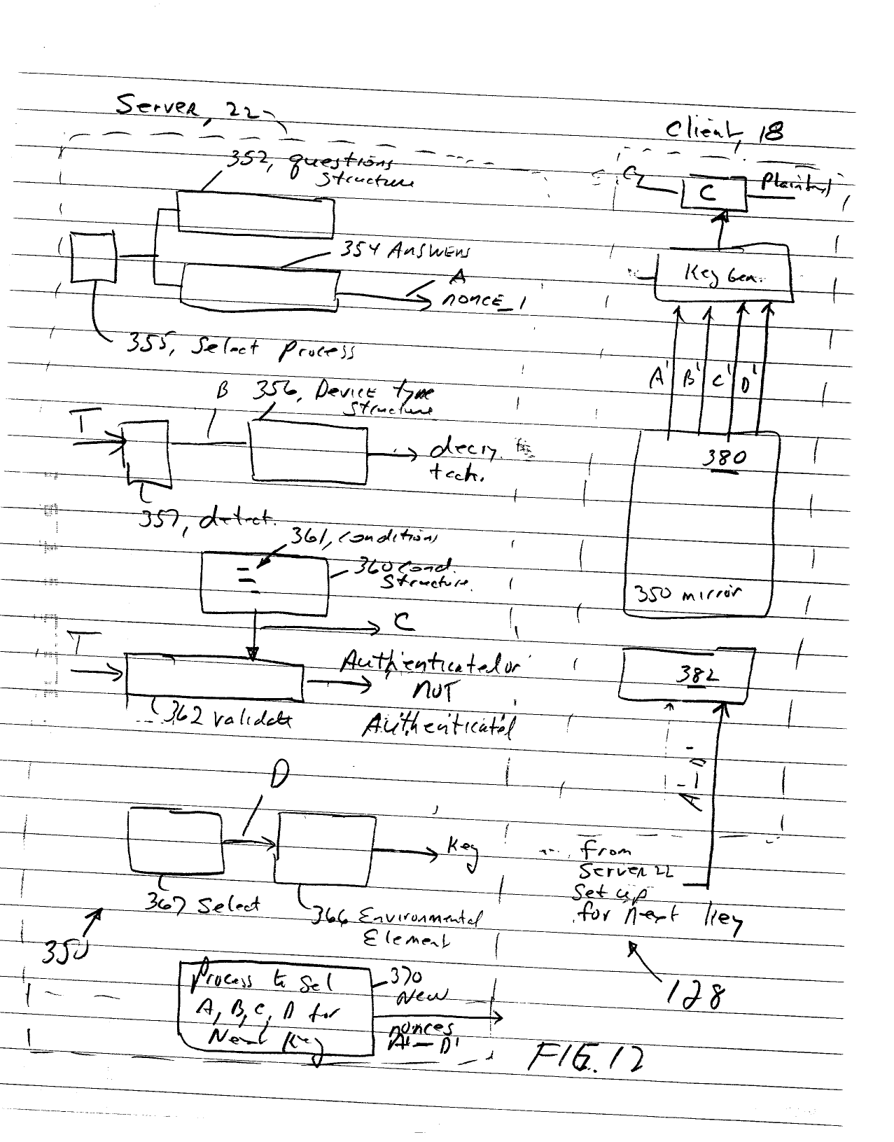

Referring to FIG. 12, the security sub process 128 is also referred to as Oscillating Nodal Encryption (ONE) key encryption. The security sub process 128 uses a key code on the POP server system 22 and a key code on, for example, devices 18 or 24 or 16. The key code is comprised of a key and nonces “A-D”, as shown that are used to add additional security to encrypting a user's PIN and make a previous transmission of the PIN useless if the PIN was intercepted or stolen. The security sub process 128 rotates a series of keys of at least four different types that are stored in memory, data structures, on the server 22 for example.

One memory data structure 352 on the server 22 includes a group of questions or information that is unique to the user. Examples of information include the user's mother's maiden name, part or all of the social security number, a PIN, the last four digits of a credit card, etc. The server 22 has a second data structure or data base 354 that stores the answers nonce “A” to the questions or a process that can parse the answer from a larger piece of information, e.g. give the fourth letter of the maiden name rather than asking for the whole name from the user. The requests are rotated randomly via a select process 355. When a transaction request is received from the client device the select process will select the proper answer to the question posed to the client, providing nonce 1.

Thus, the first time the user makes a purchase using the device, the security sub process 128 will ask for one of the pieces of information from the user. The second time it may ask for a different piece of information. It keeps changing which piece of requested information is sought. So, if a hacker were to capture that one piece of information, the additional component of the key that encrypts the PIN changes over time. If an intruder were to capture the additional component or the PIN the first time and tried to use it the second time, it would not work, since a different piece of information is being requested. Thus, by changing, i.e., oscillating those key nonces within that structure over time randomly adds one element of security.

The second structure 356 where there is rotation is data specific information to the type of device, nonce “B”. So, for example, one element of the key that's passed over could be the letter c. A process 357 would detect the correct nonce and use that nonce as a code to lookup a decryption technique from the structure 356. The letter c, if it's coming from a Palm VII, it tells the server to use the key decrypt the PIN message in a certain way where c coming from a WML device would tell it to decrypt the message in a different way. A hacker who captured that information at the air to wire security gap would not only have to know the key and how to decrypt the key, but would have to know the device through which the key was sent in order to use the correct decryption code. Each different wireless client device would handle the letter c for example in the code, differently. The second structure uses process 357 the generate the nonce to access the structure 354. The process can identify the device type from a portion of the transmission. The nonce thus selects the decryption technique to use on the PIN message.

A third structure 360 adds another layer of complexity. The third structure 360 represents a device specific condition, nonce “C”. Device specific conditions 361 are specific not only to that type of device but more particularly to that particular user's device. These can be collected on an historical basis. This can be applied to both wired and unwired devices. For example, one piece of information could be a device or device component serial number that is added to the message. Another piece of information could the time on the device. The client device could generate a timestamp as part of the transmission to the server 22. The server 22 would include a process 362 that accesses historical information from the structure 360, e.g., the device specific conditions 361. The process 362 would ascertain something about the user's device. For example, the process 362 from examination of the historical information could determine that the user's device is always off of standard time by 2-3 seconds. When a transmission is received at the server 22 the server 22 either decrypts the message to obtain the time stamp or the time stamp can be in plain text. The server 22 through process 362 compares the time stamp to a standard stable reference time, and determines a difference (delta) between the user's device and stable reference. Logs of this difference are stored in the structure 360 as a type of device specific conditions 361, for this device and other devices that are owned or typically used by the user. The process 362 would issue a message that indicates the transmission is authenticated or not authenticated.

Thus, if someone stole the PIN and uses another device that's off by 5 seconds or 2 minutes, and so forth, the server 22, via process 362 can flag the transaction as probably originating from a device that is not owned by the user and hence not authenticated. Therefore, the server can send an email to the user's account indicating this situation and either ask for a confirmation by asking a secret known only to the client and the server, before completing the transaction or allowing the user to take action against one of its accounts, e.g., disabling remote access or closing the account, or take other actions. This device specific condition 361 is distinguished from a device type specific condition because, it is relatively unique to that user's device. Other device specific conditions can be used and the server can rotate or select different ones based on different types of devices or at different transactions.

The fourth major structure is an environment specific element 366 that is added to the key, e.g., where the key encryption changes based on the day of the week or the time of the day that this transaction was processed, e.g., nonce “D”. The environment specific element 366 can store several keys, which are selected by a process 367 based on a process that examines an environmental attribute. If the user sends a PIN over a WML phone on a Monday in the AM as opposed to PM, then the client encrypts the PIN with a different key than would be used at different interval of time, e.g., if used in the PM. If an intruder steals that key and tries to use that key on Tuesday, the key would not work because it has expired. That time of expiration can be variable. The client sends several keys, some of which are rotating, data specific and user specific and others that are environment specific. The process 367 allows those keys to randomly change, i.e. oscillate, so that if the key is captured it would be useless when trying to connect to the dynamic server.

The server 22 would have a process 370 to set up nonces, e.g., A′; B′; C′ and D′ for the next, key generation on the client 18 and would send that information to the client 18 during any agreed upon transmission, preferable encrypted or possibly plaintext.

The client would have a mirror process 380 (a mirror to that on the server 22, i.e., process 350) that uses the nonces A′-D′ to produce the key used to encrypt a next transmission to the server 22, as the client had previously used nonces A-D to generate a key that was used by the server 22 as just discussed above. The client can also have a process 382 to sets up the client 18 via a encrypted message to selected various of the nonces the succeeding transmission back to the server 22. Also the nonces A′-D′ are applied to an otherwise key generator 384 to produce the key that is used to cipher plaintext and produce the encrypted cipher text message that is sent to the server for the next transmission.

The invention can be implemented in digital electronic circuitry, or in computer hardware, firmware, software, or in combinations thereof. Apparatus of the invention can be implemented in a computer program product tangibly embodied in a machine-readable storage device for execution by a programmable processor; and method actions can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks such as, internal hard disks and removable disks; magneto-optical disks; and CD_ROM disks. Any of the foregoing can be supplemented by, or incorporated in, ASICs (application-specific integrated circuits).

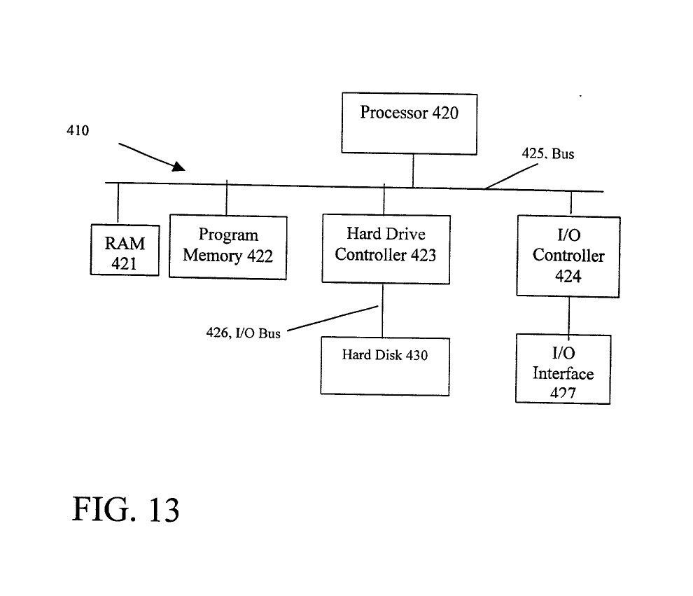

An example of one such type of computer that can be used as the server 22 or as part of some of the client devices 18 is shown in FIG. 13, which shows a block diagram of a programmable processing system (system) 410 suitable for implementing or performing the apparatus or methods of the invention. The system 410 includes a processor 420, a random access memory (RAM) 421, a program memory 422 (for example, a writable read-only memory (ROM) such as a flash ROM), a hard drive controller 423, and an input/output (I/O) controller 424 coupled by a processor (CPU) bus 425. The system 410 can be preprogrammed, in ROM, for example, or it can be programmed (and reprogrammed) by loading a program from another source (for example, from a floppy disk, a CD-ROM, or another computer).

The hard drive controller 423 is coupled to a hard disk 430 suitable for storing executable computer programs, including programs embodying the present invention, and data including storage. The I/O controller 424 is coupled by means of an I/O bus 426 to an I/O interface 427. The I/O interface 427 receives and transmits data in analog or digital form over communication links such as a serial link, local area network, wireless link, and parallel link.

Other embodiments are within the scope of the appended claims. For example the system can be configured to sign up new customers at the point of purchase. This could be the initial phase of building a profile on the customer.

What is claimed is:

1. A method for conducting electronic commerce comprising:
providing a plurality of application sub-processes that interact a client device with a server device, where the client device is prompted to divulge profile information of the user and in exchange the server sends the client device a reward that can represent a token to allow the user to achieve an advantage in purchasing goods and/or services.

2. The method of claim 1 in which the plurality of sub processes includes a pricing sub process, the pricing sub process comprises:
receiving a user connection;
receiving a user identifier from a user;
determining whether the user is contain in a user database; and
offering incentives to the user if the user is in the user database.

3. The method of claim 1 in which the plurality of sub processes includes an order of dialogue sub process, the order of dialogue sub process comprises:
receiving a user connection;
receiving a user identifier of a user;
loading user information associated with the user identifier from a user database; and
presenting the user with a plurality of options according to a history associated with the user information.

4. The method of claim 1 in which the plurality of sub processes includes a future commit sub process, the future commit sub process comprises:
receiving a user identifier from a user through a user connection;
loading a user profile associated with the user identifier from a user database;
presenting an option to the user; and
applying a discount to a purchase if the user accepts the option.

5. The method of claim 1 in which the plurality of sub processes includes negotiation sub process, the negotiation sub process comprises:
loading a user profile associated with a user identifier from a user database; and
determining a negotiation style for the user identifier.

6. The method of claim 7 in which the plurality of sub processes includes survey sub process, the survey sub process comprises:
receiving a user identifier of a user;
loading a user profile associated with the user identifier from the user database;
determining whether the user will complete a survey in return for an incentive; and
applying the incentive if the user completes the survey.

7. The method of claim 1 in which the plurality of sub processes includes currency aggregation sub process, the currency aggregation sub process comprises:
receiving an amount of a first currency from a user;
normalizing a value of the first currency amount; and
storing the value in a user database associated with the user.

8. The method of claim 1 in which the plurality of sub processes includes an electronic couponing sub process, the electronic coupon sub process comprises:
receiving a user identifier from a user;
loading a user profile associated with the user identifier from a user database;
loading a product database from a supplier site;
sending a predicted product volume for the user to the product database;
receiving a discount from the product database; and
applying the discount to a transaction of the user.

9. The method of claim 1 in which the plurality of sub processes includes a person-to-person micropayments subprocess, the micropayments sub process comprises:
receiving a user identifier from a user
quering the user for a transaction type;
presenting the user with options for the transaction type;
receiving an option selection from the user;
connecting to a payment provider; and
applying the option selection to the payment provider.

10. The method of claim 1 in which the plurality of sub processes includes cookie-free sub process, the cookie-free sub process comprising:
receiving sensitive credit information from a user;
associating the sensitive credit information with a user identifier in a user database; and
passing the user identifier without the sensitive credit information to a third party.

11. The method of claim 1 in which the plurality of sub process includes an advertising code sub process, the advertising code sub process comprises:
tagging advertisement with a code;
receiving the code from a user; and
sending information related to the code to the user.

12. The method of claim 1 in which the plurality of sub processes includes a security sub process, the security sub process comprises an Oscillating Nodal Encryption (ONE) key encryption.

13. The method of claim 12 in which the ONE key encryption comprises rotating a server code and a user code in a plurality of structures that represent a group of unique questions to a user, data specific information to a device used by a user, device specific information to a device utilized by the user and/or environmental specific information.

14. A point of purchase (POP) architecture for conducting electronic commerce comprising:
a server that includes storage device that includes:
a presentation process for interfacing with a plurality of remote systems;
an integration process for presenting a plurality of scripts to the remote systems; and
an applications process for performing electronic commerce, the applications process comprises a plurality of sub processes.

15. The architecture of claim 14 where the plurality of sub processes include:
a pricing sub process, the pricing sub process, order of dialogue sub process, a future commit sub process, negotiation sub process, survey sub process and a currency aggregation sub process.
